(19) United States
(12) Patent Application Publication
(10) Pub. No.: US 2003/0169220 A1
(43) Pub. Date: Sep. 11, 2003

(54) Display apparatus with adjusted power supply voltage

(76) Inventors: Hiroshi Tsuchiya, Hirakata-City (JP); Shoichiro Matsumoto, Oogaki-City (JP)

Correspondence Address: MCDERMOTT, WILL & EMERY, 600 13th Street, N.W., Washington, DC, 20005-3096, US

(21) Appl. No.: 10/359,283

(22) Filed: Feb. 6, 2003

(30) Foreign Application Priority Data
Mar. 7, 2002 (JP) JP2002-062033

(51) Int. Cl. G09G 3/34

(52) U.S. Cl. 345/84

(57) ABSTRACT

A display apparatus includes an organic light emitting diode (OLED) which serves as an optical element, a first transistor which serves as a switch for writing luminance data and a second transistor which drives the OLED. A cathode of the OLED is connected to a constant voltage, and a source electrode of the second transistor is connected to a power supply voltage via a power supply line. Potential of the constant voltage is set to a negative value whereas potential of the power supply voltage is set to a positive value. Thus, the difference between the absolute values of the constant voltage and the power supply voltage becomes small compared to a case where the constant voltage is set to 0 V.

### BACKGROUND OF THE INVENTION

1. Field of the Invention

The present invention relates to a display apparatus and more particularly to an active-matrix type display apparatus.

2. Description of the Related Art

The use of notebook-type personal computers and portable terminals is spreading rapidly. Displays mainly used for such equipment are liquid crystal displays, but the display considered promising as a next-generation flat display panel is the organic EL (Electro Luminescence) display. And the active matrix drive system is central as a display method for such displays. The display using this system is called the active matrix display where a multiplicity of pixels are vertically and horizontally disposed in a matrix, and a switching element is provided for each pixel. Image data are written into each scanning line sequentially by the switching element.

The research and development for designing practical organic EL displays is now in the pioneer days, when a variety of pixel circuits are being proposed. One example of such circuits is a pixel circuit disclosed in Japanese Patent Application Laid-Open No. Hei11-219146, which will be briefly explained hereinbelow with reference to FIG. 4.

Referring to FIG. 4, this circuit is comprised of a first transistor Tr50 and a second transistor Tr51 which are two n-channel transistors, an organic light emitting diode OLED50 which is an optical element, a storage capacitance C50, a select line SL50 which sends a select signal, a data line DL50 through which luminance data is transmitted, and a power supply line PL50. The power supply line PL50 is connected to a power supply voltage Vdd. Potential at a cathode electrode of the OLED50 is the same as ground potential.

This circuit operates as follows. To write luminance data of the OLED 50, the select signal of the select line SL50 turns high and the first transistor Tr50 turns on, and luminance data inputted to the data line DL50 is set in both the second transistor Tr51 and the storage capacitance C50. Then, the current corresponding to the luminance data flows so as to cause the OLED 50 to emit light. When the select signal of the select line SL50 becomes low, the first transistor Tr51 turns off but voltage at the gate of the second transistor Tr51 is maintained, so that luminescence continues according to the set luminance data.

One of the problems to be overcome by the present invention is the large power consumption of organic EL displays. The optical elements used for organic EL displays generally cause large drops in voltage, and thus the electric power required for the operation of such a display apparatus as a whole is relatively large. For example, a display apparatus as shown in FIG. 4 requires a power supply voltage Vdd which may be as high as 15V to 20V.

### SUMMARY OF THE INVENTION

The present invention has been made in view of the foregoing circumstances and an object thereof is to provide a novel circuit that reduces power consumption. Another object of the present invention is to lower the voltage that works on driving elements when activating a display apparatus. Still another object of the present invention is to lower the voltage that works on optical elements when activating the display apparatus. Still another object of the present invention is to raise an electron injection efficiency at organic light emitting diodes. Still another object of the present invention is to reduce the manufacturing cost of the display apparatus.

A preferred embodiment according to the present invention relates to a display apparatus. This apparatus includes: an optical element; a drive element which drives the optical element; and first and second voltage sources to drive the drive element. Each of the first voltage source and second voltage source has positive and negative voltage values, and the voltage value of the voltage source which is of the positive voltage value is lower than a breakdown voltage of the drive element. What may be principally assumed here as an “optical element” is an organic light emitting diode (referred to as OLED hereinafter). One of the two voltage sources utilized to drive the optical element is generally set to the same potential as ground potential. However, even if there is no change in potential difference between the two voltage sources, absolute values of potentials thereof will fall within a range of small values by shifting the two voltage sources to the negative side. Making a voltage of the voltage source, which is of a positive value, lower than a breakdown voltage of the drive element results in the lowering of a voltage that works on the drive element at start-up, so that reliability of the drive elements can be improved. Here, the “breakdown voltage” concerns a gate-source voltage or gate-drain voltage of the drive element, and it does not mean a dielectric breakdown voltage. Though this “breakdown voltage” differs depending on the structure or process condition of a transistor, it is generally about 15 V.

Another preferred embodiment according to the present invention relates also to a display apparatus. This apparatus also includes: an optical element; a drive element which drives the optical element; and first and second voltage sources to drive the drive element. Each of the first voltage source and second voltage source has positive and negative voltage values, and an absolute value of the voltage value of the voltage source which is of the negative voltage value is lower than a breakdown voltage of the optical element. Thus, the voltage value of the voltage source which is of a negative value is kept lower than a breakdown voltage of the optical element, so that a load on the optical element at start-up is reduced and its reliability can be improved. Here, the “breakdown voltage” means a voltage applied to both ends of the optical element, and its value is generally about 15V under biasing in forward direction and about 20V under biasing in the reverse direction though this “breakdown voltage” differs depending on the structure or process condition of an OLED.

Moreover, this display apparatus may further include a switch circuit which switches a write and store of luminance data. This “luminance data” means data concerning luminance or brightness information to be set in the drive element, and is distinguished from the intensity of light emitted by the optical element. Moreover, what may be principally assumed here as the “drive element” or “switching element” is an MOS (Metal Oxide Semiconductor) transistor or a TFT (Thin Film Transistor). Here, if absolute values of voltages applied to the both ends of the drive element are made small, then the absolute value of a voltage for luminance data written to the drive element can also be made small. Moreover, an absolute value of a select signal applied to the switching circuit also becomes small. Thus, the power consumption can be reduced in the apparatus as a whole.

Moreover, the absolute value of the voltage value of the voltage source which is of a negative voltage value may be greater than or equal to a threshold voltage of the optical element. Here, in the voltage-luminance (V-L) characteristics of the OLED, a minimum voltage Vmin in order to obtain a minimum luminance Lmin must be greater than or equal to a threshold voltage Vf. Thus, the luminance data to be set in the gate electrode of the drive element must be at least greater than or equal to the minimum voltage Vmin. If it is intended that the minimum value of this luminance data be set to zero, potential at the cathode of the OLED needs to be shifted by the minimum voltage Vmin in the negative direction and this can be done by the above-described structure. Thus, the voltage of the luminance data is lowered and the power consumption can be reduced.

In such a display apparatus described above, the optical element may be set in a manner such that a constant voltage is applied to at least one end of the optical element by the first voltage source or second voltage source and such that each of potentials at both ends of the optical element has approximately the same absolute value in the positive and negative. Thereby, the absolute values can be made small averagely in the positive side and negative side even if there is no change in potential difference at the both ends, so that the absolute values of voltages that work on the both ends of the optical element can be minimized. Thus, the electric power required can be minimized, too.

In such a display apparatus described above, the optical element may be set in a manner such that the optical element operates when luminance data is written with a voltage of a predetermined range being applied to the drive element, and a range of the luminance data may be set on the basis of a voltage value of luminance data, corresponding to a predetermined color, which becomes zero. In this case, the power consumption of the display apparatus as a whole can be reduced around the voltage of the luminance data. Here, the “predetermined color” means color included in a range of effective display colors. For example, though an effective range corresponding to the effective range of the display color can be considered for the voltage value of the luminance data, it is possible that a small voltage results in a black display depending on the minimum value while it is possible that a large value results in a while display depending on the maximum value. However, voltages that lie within the effective range only are treated here, and voltages other than such voltages in the effective range will not be considered.

It is to be noted that any arbitrary combination of the above-described structural components, and expressions changed between a method, an apparatus, a system and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a structure of a pixel circuit for a single pixel, according to a first embodiment of the present invention.

FIG. 2 shows a structure of pixel circuits for four pixels and their peripheral control circuits and signal lines, according to the first embodiment.

FIGS. 3A and 3B show relationships between two voltages to be applied to both ends of an OLED and voltages of luminance data according to a second embodiment.

FIG. 4 shows a circuit structure for a single pixel, according to the conventional practice.

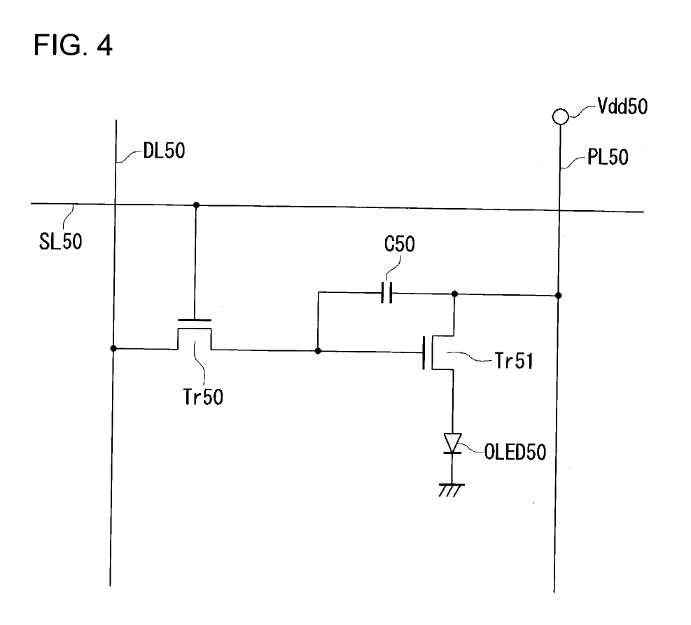

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the following embodiments, an active matrix organic EL (Electro Luminescence) display is assumed as a display apparatus. The present invention will be described with reference to the following some best modes for carrying out the invention.

First Embodiment

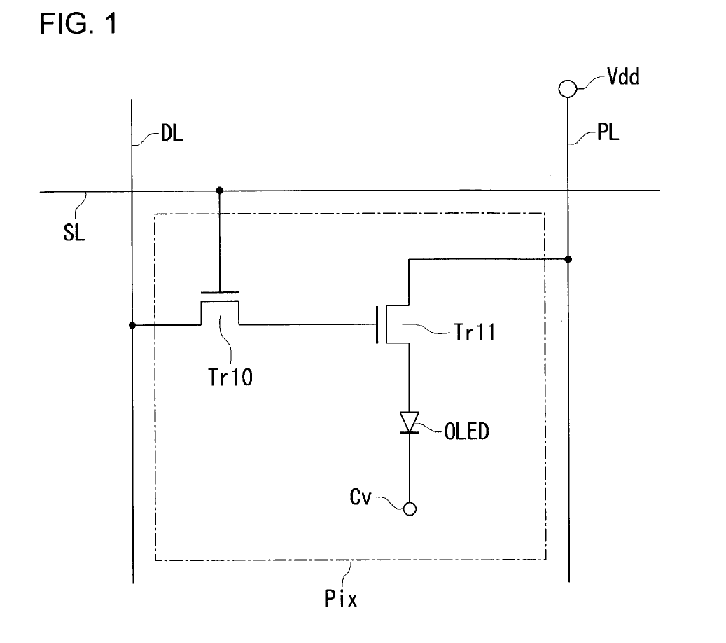

FIG. 1 shows a structure of a pixel circuit for a single pixel. A pixel circuit Pix includes a first transistor Tr10, a second transistor Tr11, an OLED and a constant voltage Cv. Disposed around the pixel circuit Pix are a data line DL, a select line SL, and a power supply line PL. The data line DL transmits luminance data to be written into the pixel circuit Pix, whereas the select line SL transmits select signals that determine luminance data write timing. The power supply line PL supplies electric power to the pixel circuit Pix.

The first transistor Tr10 and the second transistor Tr11 are both n-channel transistors. The first transistor Tr10 is a switching circuit which controls luminance data writing. A gate electrode of the first transistor Tr10 is connected to the selection line SL, a drain electrode (or a source electrode) of the first transistor Tr10 is connected to the data line DL, and the source electrode (or the drain electrode) of the first transistor Tr10 is connected to a gate electrode of the second transistor Tr11. The second transistor Tr11 is a drive element which drives the OLED. A drain electrode of the second transistor Tr11 is connected to the power supply line PL and a source electrode of the second transistor Tr11 is connected to an anode of the OLED. A cathode of the OLED is connected to the constant voltage Cv. The power supply line PL is connected to a power supply voltage Vdd. The constant voltage Cv is a voltage lower than the power supply voltage Vdd. It is to be understood that these power supply voltage Vdd and constant voltage Cv correspond to “first voltage source and second voltage source”, respectively, stated in what is claimed.

The constant voltage Cv is set at −7V. The power supply voltage Vdd is set at +8V. Generally, however, the constant voltage Cv is set at 0V which is equal to ground potential, and the power supply voltage Vdd is often set at about +15V. According to a first embodiment of the present invention, the constant voltage is shifted by 7V in the negative side, so that the absolute values of voltage at both ends of the OLED become nearly equal to each other. Thereby, the power consumption can be reduced. Moreover, since the potential at the cathode of the OLED is set to a negative, the injection efficiency of electrons which are the carrier of charge can be raised.

An operation of a circuit structured as above will be described hereinbelow. As the select signal goes high in the select line SL, the first transistor Tr10 turns on and luminance data that has flowed through the data line DL is set in the gate electrode of the second transistor Tr11. A current corresponding to a gate-source voltage at the second transistor Tr11 flows, and the OLED emits light at an intensity corresponding to this current.

The voltage for luminance data to be set in the second transistor Tr11 is determined in accordance with a source potential of the second transistor Tr11. Here, it is determined according to the potential at the anode of the OLED, which is connected to the source of the second transistor Tr11. In the present embodiment, the potential at the cathode of the OLED is set about 7V below a normal level, so that the potential at the anode of the OLED becomes lower by the same amount. Accordingly, the voltage for luminance data to be set in the second transistor Tr11 can also be lowered, thereby contributing to the reduction of power consumption. In a case where a p-channel transistor is used for the second transistor Tr11, the source of the second transistor Tr11 will be equal to the potential of the power supply voltage Vdd. In this case, too, the power supply voltage Vdd is set about 7V lower than a normal level, so that the similar effect of reduced power consumption results.

The voltage that works on the second transistor Tr11, which is a driver element, at the time of activating a display apparatus can be lowered. Namely, if the power supply voltage Vdd is generally 15 to 20V, the potential difference thereof from the gate potential, which is 0V at start-up, will be 15 to 20V. According to the present embodiment, on the other hand, the potential difference is 8V because the power supply voltage Vdd is 8V whereas the gate potential at start-up is 0V. Thus, the voltage that works on the second transistor Tr11 is reduced, thereby making its load smaller. And provided that the potential difference is smaller than a breakdown voltage of the second transistor Tr11, the reliability thereof can be maintained or even improved.

Moreover, the voltage that works on the OLED, which is an optical element, at the time of activating the display apparatus can be lowered. That is, when the potential of the constant voltage Cv is shifted to the negative side, the reliability of the OLED can be maintained or even improved by making this shifted constant voltage Cv smaller than a breakdown voltage value of the OLED.

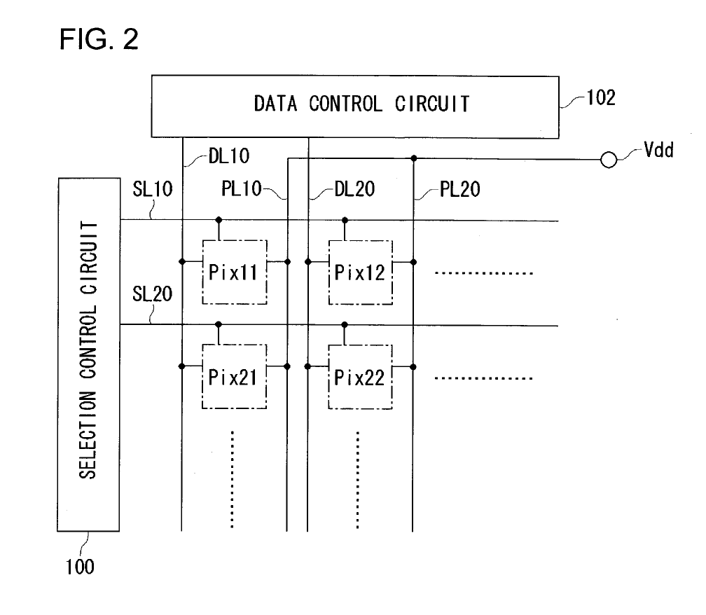

FIG. 2 shows a structure of pixel circuits for four pixels and their peripheral control circuits and signal lines. Though a multiplicity of pixel circuits are disposed in a matrix to form a display panel, this FIG. 2 represents the pixel circuits for only four pixels of them, namely, first to fourth pixel circuits Pix11, Pix12, Pix21 and Pix22. A first select line SL10 transmits a “high” select signal at a timing of writing luminance data to the first and second pixels Pix11 and Pix12 on a first row. A second select line SL20 transmits a “high” select signal at a timing of writing luminance data to the third and fourth pixels Pix21 and Pix22 on a second row.

A first data line DL10 transmits luminance data to be written into the first and third pixels Pix11 and Pix21 on a first column. A second data line DL20 transmits luminance data to be written into the second and fourth pixels Pix12 and Pix22 on a second column. A first power supply line PL11 supplies electric power to the first and third pixels Pix11 and Pix21 on the first column. A second power supply line PL21 supplies electric power to the second and fourth pixels Pix12 and Pix22 on the second column.

A selection control circuit 100 generates select signals to be transmitted to the first and second select lines SL10 and SL20. That is, a voltage value of a select signal is determined by the selection control circuit 100. A data control circuit 102 generates luminance data to be transmitted to the first and second data lines DL10 and DL20. That is, a voltage value of luminance data is determined by the data control circuit 102.

Second Embodiment

A second embodiment according to the present invention differs from the first embodiment in that the power supply voltage included in the display apparatus is set on the basis of the voltage of luminance data. In other words, the voltage of luminance data corresponding to a predetermined color is set to be zero, and voltage values of other voltage sources are set such that the whole system operates in accordance with the thus set voltage of luminance data.

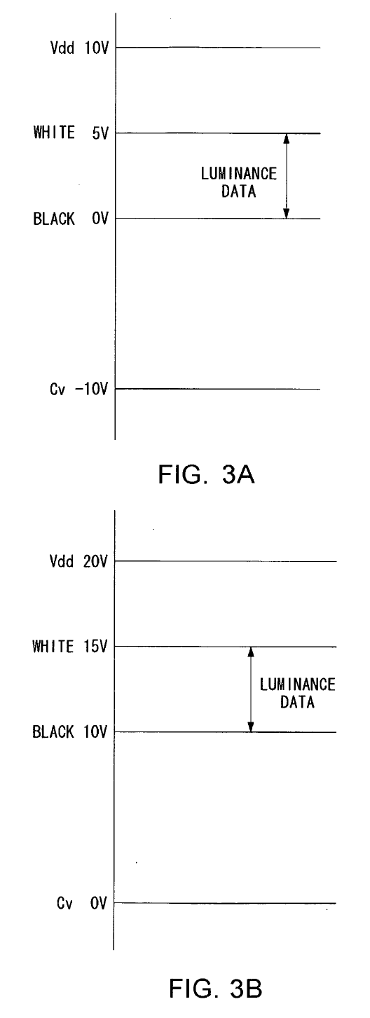

FIGS. 3A and 3B show relationships between the two voltages to be applied on both ends of a system where the OLED and the second transistor Tr11 are connected in series with each other and the voltages of luminance data. FIG. 3A shows the voltages according to the present embodiment whereas FIG. 3B shows the voltages of a generally used configuration. As shown in FIG. 3B, in such a general arrangement where 0V as a constant voltage Cv is set at the cathode of an OLED, the value of the power supply voltage Vdd is 20V, for instance, and hence the values of voltage for luminance data will be in the range of 10V to 15V from black to white.

According to the present embodiment, however, as shown in FIG. 3A, the constant voltage Cv and the power supply voltage Vdd are set in such a manner that the values of voltage for luminance data are in the neighborhood of zero. Here, the constant voltage Cv and the power supply voltage Vdd are so set that the voltage for luminance data corresponding to black is 0V. The range of luminance data is 0V to 5V from black to white. Adjusted to this scheme, the constant voltage Cv is −10V, and the power supply voltage Vdd 10V. As is evident, the absolute values of voltage in FIG. 3B are 10 to 15 and 0 to 20 whereas the absolute values of voltage in FIG. 3A are 0 to 5 and 0 to 10, respectively, thereby contributing to a reduction in power consumption of the display apparatus as a whole.

Moreover, in a case where the range of luminance data in FIG. 3A is determined in a manner such that the value of voltage for luminance data corresponding to white is 0V, the constant voltage Cv will accordingly be −15V, and the power supply voltage Vdd 5V. If the range of luminance data is so determined that the value of voltage for luminance data corresponding to the color in the middle of black and white is 0V, then the constant voltage Cv will accordingly be −12 to −13V, and the power supply voltage Vdd 7 to 8V. Thus, the power consumption of the display apparatus can also be reduced by choosing small absolute values for voltages at different parts of the apparatus on the basis of the value of voltage for luminance data.

The present invention has been described based on embodiments which are only exemplary. It is understood by those skilled in the art that there exist other various modifications to the combination of each component and process described above and that such modifications are encompassed by the scope of the present invention. Such modifications will be described hereinbelow.

The first transistor Tr10 may be structured in such a manner that a plurality of transistors are connected in series. In such an arrangement, characteristics, such as current amplification factor, of the transistors may be made to differ from one another. For example, setting the current amplification factor of a transistor in the first transistor Tr10 disposed closer to the second transistor Tr11 to a low level may produce a marked effect of reducing leakage current. Moreover, the characteristics of the first transistor Tr10 and the second transistor Tr11 may be varied. For example, if the current amplification factor of the second transistor Tr11 is made smaller, then the range of setting data corresponding to the same luminance range will be broader, thus making it easier to control the luminance.

In the second embodiment, 0V to 5V are set as voltages for the luminance data. As a modified example, however, the voltages may be set to 1V to 5V so as to be compatible with the general luminance data in a liquid crystal display and at the same time a driver for use with liquid crystal display such as LC15004 (trademark) of Sanyo Electric Co., Ltd. or μ PD16491 (trademark) of NEC Corporation may be used as the data control circuit 102. Thereby, the manufacturing cost of display apparatus can be reduced. Similarly, when a negative voltage is set for the constant voltage Cv, a power supply of alternating voltage used in the liquid crystal may be utilized so as to reduce the manufacturing cost.

Although the present invention has been described by way of exemplary embodiments, it should be understood that many changes and substitutions may further be made by those skilled in the art without departing from the scope of the present invention which is defined by the appended claims.

What is claimed is:

1. A display apparatus, including:
an optical element;
a drive element which drives said optical element; and
first and second voltage sources to drive said drive element,
wherein each of said first voltage source and second voltage source has positive and negative voltage values, and the voltage value of said voltage source which is of the positive voltage value is lower than a breakdown voltage of said drive element.

2. A display apparatus, including:
an optical element;
a drive element which drives said optical element; and
first and second voltage sources to drive said drive element,
wherein each of said first voltage source and second voltage source has positive and negative voltage values, and an absolute value of the voltage value of said voltage source which is of the negative voltage value is lower than a breakdown voltage of said optical element.

3. A display apparatus, including:
an optical element;
a drive element which drives said optical element; and
first and second voltage sources to drive said drive element,
wherein each of said first voltage source and second voltage source has positive and negative voltage values, and an absolute value of the voltage value of said voltage source which is of the negative voltage value is greater than or equal to a threshold voltage of said optical element.

4. A display apparatus according to claim 1, wherein a constant voltage is applied to at least one end of said optical element by said first voltage source or said second voltage source, and potentials at both ends of said optical element are set in a manner such that the potentials are positive and negative, and absolute values thereof are approximately equal to each other.

5. A display apparatus according to claim 2, wherein a constant voltage is applied to at least one end of said optical element by said first voltage source or said second voltage source, and potentials at both ends of said optical element are set in a manner such that the potentials are positive and negative, and absolute values thereof are approximately equal to each other.

6. A display apparatus according to claim 3, wherein a constant voltage is applied to at least one end of said optical element by said first voltage source or said second voltage source, and potentials at both ends of said optical element are set in a manner such that the potentials are positive and negative, and absolute values thereof are approximately equal to each other.

7. A display apparatus according to claim 1, wherein said optical element is set in a manner such that said optical element operates when luminance data is written with a voltage of a predetermined range being applied to said drive element, and wherein a range of the luminance data is set on the basis of a voltage value of luminance data, corresponding to a predetermined color, which becomes zero.

8. A display apparatus according to claim 2, wherein said optical element is set in a manner such that said optical element operates when luminance data is written with a voltage of a predetermined range being applied to said drive element, and wherein a range of the luminance data is set on the basis of a voltage value of luminance data, corresponding to a predetermined color, which becomes zero.

9. A display apparatus according to claim 3, wherein said optical element is set in a manner such that said optical element operates when luminance data is written with a voltage of a predetermined range being applied to said drive element, and wherein a range of the luminance data is set on the basis of a voltage value of luminance data, corresponding to a predetermined color, which becomes zero.

10. A display apparatus according to claim 1, wherein voltage ranges of said first voltage source and second voltage source are set in a manner such that absolute values of voltages of said first and second voltage sources fall within a range smaller than a case when one of said first voltage source and second voltage source is set to ground potential.

11. A display apparatus according to claim 2, wherein voltage ranges of said first voltage source and second voltage source are set in a manner such that absolute values of voltages of said first and second voltage sources fall within a range smaller than a case when one of said first voltage source and second voltage source is set to ground potential.

12. A display apparatus according to claim 3, wherein voltage ranges of said first voltage source and second voltage source are set in a manner such that absolute values of voltages of said first and second voltage sources fall within a range smaller than a case when one of said first voltage source and second voltage source is set to ground potential.

13. A display apparatus according to claim 1, wherein said voltages sources are structured such that either said first voltage source or said second voltage source which is connected to a cathode of said optical element is of negative potential.

14. A display apparatus according to claim 2, wherein said voltages sources are structured such that either said first voltage source or said second voltage source which is connected to a cathode of said optical element is of negative potential.

15. A display apparatus according to claim 3, wherein said voltages sources are structured such that either said first voltage source or said second voltage source which is connected to a cathode of said optical element is of negative potential.

16. A display apparatus according to claim 7, wherein the predetermined color is color in the middle of black and white.

17. A display apparatus according to claim 8, wherein the predetermined color is color in the middle of black and white.

18. A display apparatus according to claim 9, wherein the predetermined color is color in the middle of black and white.
